(19) United States
(12) Patent Application Publication
(10) Pub. No.: US 2025/0034006 A1
(43) Pub. Date: Jan. 30, 2025

(54) ELECTROKINETIC DISRUPTION GENERATION

(71) Applicants: HOWARD FRANCIS ALBOROUGH, Botrivier (ZA); PAMELA ST CLARE ALBOROUGH, Botrivier (ZA)

(72) Inventors: HOWARD FRANCIS ALBOROUGH, Botrivier (ZA); PAMELA ST CLARE ALBOROUGH, Botrivier (ZA)

(21) Appl. No.: 18/845,141

(22) PCT Filed: Feb. 24, 2023
(86) PCT No.: PCT/IB2023/051732

§ 371 Date: Sep. 9, 2024

(30) Foreign Application Priority Data
Mar. 7, 2022 (ZA) 2022/02688

(51) Int. Cl. C02F 1/461; C02F 1/467

(52) U.S. Cl. CPC C02F 1/46109; C02F 1/4672; C02F 2001/46123; C02F 2001/46138; C02F 2001/46152; C02F 2201/46135; C02F 2201/46175

(57) ABSTRACT

The current invention relates to an electrokinetic disruption generation system for generation of a pulsed electric field (PEF) in a fluid, including but not limited to a fluid from treatment plant effluent, industrial effluent, agricultural waters, marine water, and reused or recycled water, the electrokinetic disruption generation system comprising a plurality of non-parallel electrode plates connected or connectable to a power supply circuit to form an electrode circuit, and a zinc electron sink connected or connectable to the electrode circuit.

### FIELD OF THE INVENTION

The current invention relates to an electrokinetic disruption generation system for generation of a pulsed electric field (PEF) in a fluid, including but not limited to a fluid from treatment plant effluent, industrial effluent, agricultural waters, marine water, and reused or recycled water, the electrokinetic disruption generation system comprising a plurality of non-parallel electrode plates connected or connectable to a power supply circuit to form an electrode circuit, and a zinc electron sink connected or connectable to the electrode circuit.

The current invention further relates to a method for treating a fluid including by killing and/or removal of microorganisms, disruption of materials such as suspended solids and macromolecules, and aggregation of colloids for further separation from the treated fluid by solid/liquid separation, the method comprising generation of a pulsed electric field (PEF) within the fluid with the use of the electrokinetic disruption generation system of the invention.

### BACKGROUND OF THE INVENTION

Various electronic fluid treatment systems are known. For example WO 2004/041730 and US2008/0190863 describe methods of treating fluid using a pulsed electric field.

WO2009/156840 describes an electronic fluid treatment system having an electrode assembly comprising multiple electrodes that are secured rigidly at a first axial end to a mounting and secured at a remote end to the first axial end by silicon grommets, thereby to maintain the required spacing between the oppositely charged electrodes, in use, and prevent the individual electrodes from touching each other. However, this electrode assembly has a drawback in that the positioning of the electrode plates allows for a significant portion of the fluid to be treated to bypass the reactive area between the plates, thereby resulting in a portion of the fluid not being treated.

Furthermore, due to the rigid mounting in resin of the electrode plates to prevent corrosion of electrical connections and due to the grommets for separation of the electrode plates, vibration of the electrode assembly is reduced. Maximal vibration of the electrode plates is essential for sonic wave enhancement, for renewal of the boundary layer, including Helmholtz layer on the electrode plates, thereby to facilitate efficient electrophoresis, and for effective destruction of microorganisms.

There is therefore a need for an improved electronic fluid treatment system that provides maximal vibration at each electrical pulse and thereby facilitates electromagnetic acceleration of charged particles on the surface of the electrode plates and clears the surface of the electrodes (i.e. the boundary layer) for fresh chemical reactions at the next electrical pulse. Furthermore it would be useful if such maximal vibration was able to facilitate a sonic pulsed wave for deactivation of microorganisms by breaking down or electroporating the double lipidic cell layer of the plasma membrane of microorganisms and breaking down the protective mucous coatings on microorganisms, as well as disruption of the structure of organic molecules and particulate materials.

### SUMMARY OF THE INVENTION

According to a first embodiment of the invention, there is provided an electrokinetic disruption generation system for generation of a pulsed electric field (PEF) in a fluid to be treated comprising:
a housing defining a fluid inlet and outlet that in use facilities a flow of the fluid to be treated through the housing;
within the housing, two or more flat, substantially rectangular, electrode plates having a first short end and a second short end and a first long edge and a second long edge, disposed side-by-side in a non-parallel orientation relative to each other, with the planar surface of each electrode plate being angularly spaced relative to the planar surface of an adjacent electrode plate and wherein the edges of each electrode plate are coated with a composite rubber compound;
a mount ring connected or connectable to the housing, having an inner surface comprising a plurality of slots opposed, but offset relative to each other by 0.5 mm, and through which the first short end of the two or more elongate electrode plates passes, such that the slots guide the first short end of the elongate electrode plates such that the planar surface of each electrode plate is angularly spaced relative to the planar surface of an adjacent electrode plate;
optionally at least one electrode plate guide ring disposed within the housing, having an inner surface comprising a plurality of slots opposed, but offset relative to each other by 0.5 mm, and through which the two or more elongate electrode plates pass such that the slots guide the first and second long edges of the elongate electrode plates such that the planar surface of each electrode plate is angularly spaced relative to the planar surface of an adjacent electrode plate;
a power supply connected or connectable to the first end of each elongate electrode plate to form an electrode circuit;
a zinc electron sink connected or connectable to the electrode circuit,
wherein the spacing between the mount ring slots and the electrode plates and between the optional electrode plate guide ring slots and the electrode plates permits a maximum of 0.2 mm relative movement between the mount ring slots and each electrode plate and between the optional plate guide ring slots and the electrode plates, and
wherein the planar surfaces of the non-parallel electrode plates are spaced not less than 4 mm, or multiples of 4 mm, from each other.

Composite rubber compounds are well known in the art and comprise a rubber matrix and a reinforcing material so that high strength to flexibility ratios can be achieved. For example, the composite rubber compound may comprise a styrene-butadiene rubber composite, a silica rubber composite, a zinc oxide rubber composite, or a nano-filler or nano-structured filler such as graphene, nano-graphite, silica, carbon nanotubules and the like.

Preferably, the non-parallel, angular spacing of one electrode plate relative to an adjacent plate results in the two adjacent plates being angled relative to each other such that the distance between the adjacent two electrode plates is 0.5 mm greater between a first long edge of the two electrode plates compared to the distance between a second, opposed long edge of the two electrode plates.

The electrode plates are typically comprised of titanium, in particular coated with one or more platinum group metals or metal oxides.

Typically, the fluid treatment system further includes a controller for operably providing alternating first and second pulsed power feeds from the power supply circuit, at first and second voltages respectively, to the electrode plates, such that for an adjacent pair of electrode plates, a first electrode plate is fed one of the pulsed power feed and a second electrode is fed the other of the pulsed power feed, thereby causing the electrode plates to move relative to each other and to the mount ring and optional plate guide ring slots, under the influence of the pulsed power feed-generated electromotive force.

In particular, the controller can vary the voltage amplitude and the frequency of the power pulses.

Preferably, the fluid treatment system further includes a variable inductance associated with the controller to vary the wave front form of the power pulses.

Further preferably, the wave front form of the power pulses is a square wave front form but by using duty cycle within the square peak the peak power period can be shortened to control current flow, and then by adding inductance, the shape of the front of each peak can be controlled so that the duty cycle can be shortened at the point where the capacitance of the electrodes becomes fully charged.

Generally the frequency of the power pulses is between 1 kHertz and 200 kHertz; and (ii) the voltage amplitude is between 12.5 V/cm and 150 V\cm.

In particular, the electrokinetic disruption generation system of the invention by means of the electrode plate movement results in an ultrasound interaction with the fluid being treated, which together with the shaped wave front generated, results in a highly aggressive and disruptive oxidising environment that enhances the advanced oxidation process (AOP) that occurs in the system and is derived from breaking down water molecules in the fluid being treated to obtain active oxygen that then forms ozone (O₃), peroxide (H₂O₂) and hydroxyl (OH) radicals.

According to a further embodiment of the invention, there is provided a method of treating a fluid, including but not limited to fluid from treatment plant effluent, industrial effluent, agricultural waters, marine water, and reused or recycled water with the electrokinetic disruption generation system of the invention. In particular, the method comprises a step of enhancing an advanced oxidation process (AOP) that occurs in the system and is derived from breaking down water molecules in the fluid being treated to obtain active oxygen that then forms ozone (O₃), peroxide (H₂O₂) and hydroxyl (OH) radicals.

In the method of treating a fluid, the electrokinetic disruption generation system may be used together with one or more additional treatment or purification systems either before and/or after the electrokinetic disruption treatment of the fluid, including solid/liquid separation such as by filtration or sedimentation.

According to a further embodiment of the invention, there is provided an electrokinetic disruption generation system of the invention, substantially as described and illustrated in any of the accompanying Figures.

According to a further embodiment of the invention, there is provided a method of treating a fluid with the electrokinetic disruption generation system of the invention, substantially as described in any of the illustrated embodiments.

### BRIEF DESCRIPTION OF THE DRAWINGS

The invention will now be further described, by way of example, with reference to the accompanying drawings.

FIG. 1 is a perspective view of one possible embodiment of the electrokinetic disruption generation system invention showing the mount ring, 18 non-parallel electrode plates and electrode plate guide rings;

FIG. 2 is a photograph of a electrokinetic disruption generation system according to one embodiment of the invention;

FIG. 3 shows a schematic representation of the angular spacing of a plurality of electrode plates relative to each other as positioned within the slots of the mount or electrode plate guide ring;

FIG. 4 shows a graph of the inverse gas flow per second versus spacing difference between non-parallel electrode plates compared with parallel electrode plates; and

FIG. 5A) shows the peak shape of the wave front form of the power pulses with no control and B) shows the peak shape of the wave front form of the power pulses variable with inductance and duty cycle control.

### DETAILED DESCRIPTION OF THE INVENTION

The following description of the invention is provided as an enabling teaching of the invention, is illustrative of the principles of the invention and is not intended to limit the scope of the invention. It will be understood that changes can be made to the embodiment/s depicted and described, while still attaining beneficial results of the present invention. Furthermore, it will be understood that some benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention.

The current invention relates to an electrokinetic disruption generation system for generation of a pulsed electric field (PEF) in a fluid, including but not limited to a fluid from treatment plant effluent, industrial effluent, agricultural waters, marine water, and reused or recycled water, the electrokinetic disruption generation system comprising a plurality of non-parallel electrode plates connected or connectable to a power supply circuit to form an electrode circuit, and a zinc electron sink connected or connectable to the electrode circuit.

Movement in the non-parallel electrode plates is provided by the electromotive force generated by the pulsed power supplied to them in such a manner that physical disruption of the electrochemical boundary layer on the electrode plates is achieved with each pulse, providing a mechanism for enhancement of renewal of the boundary layer. Additionally, the movement provides an ultrasound effect on the fluid passing through the system, which enhances chemical reactions and assists in disruption of materials such as suspended solids and macromolecules, and lysis in biological cell materials.

The electrode movement, shaped wave force and ultrasound interaction in the reactor cell results in a highly aggressive and disruptive oxidising environment that enhances the advanced oxidation process (AOP) that occurs in the system and is derived from breaking down water molecules in the fluid being treated to obtain active oxygen that then forms ozone (O₃), peroxide (H₂O₂) and hydroxyl (OH) radicals.

Angular (non-parallel) mounting of the electrode plates provides lateral movement of ions and charged particulate materials to enhance migration and boundary layer renewal while providing an amplification of the sonic effect.

A power supply is connected to the electrodes such that alternate electrodes are connected in parallel in order to simultaneously apply identical power to each electrode by the power supply. The power supply is adapted to provide a pulsed voltage at an amplitude and frequency dependent on the treatment result required in a specific fluid medium, the spacing between them and power applied such that the electrodes, in use, provide a capacitive dielectric discharge effect. A variable inductance is included in the power supply in order to control the wave front form of the pulsed power.

As shown in Table 1, the applicant has found that inclusion of a zinc electrode sink in the electrode circuit significantly enhances the electrochemical reactions in the electrokinetic disruption generation system by acting as a catalyst for the electrochemical reactions and thereby significantly increases reaction rate.

TABLE 1
Effect of Zn electrode sink at minimum average voltage
Test for Zn Effect at Min Ave Voltage
Time to 40 ml Gas Volume in Seconds

| | | | | | | | | | | | |
|---|---|---|---|---|---|---|---|---|---|---|---|
| With Zn | 12 V - 1 | 8 | 8 | 8 | 8 | 8 | 8 | 8 | 8 | 8 | 8 |
| | 12 V - 2 | 9 | 9 | 9 | 9 | 9 | 9 | 9 | 9 | 9 | 9 |
| Without Zn | 12 V - 1 | 10 | 11 | 10 | 10 | 9 | 10 | 10 | 11 | 9 | 10 |
| | 12 V - 2 | 10 | 11 | 10 | 10 | 10 | 10 | 10 | 10 | 10 | 11 |

Gas Generation Average

| | | | | |
|---|---|---|---|---|
| 8.5 | Ave 12 V With Zn | 12 V % Reaction Rate | 18.8 | % |
| | | Improvement With Zn | | |
| 10.1 | Ave 12 V Without Zn | | | |

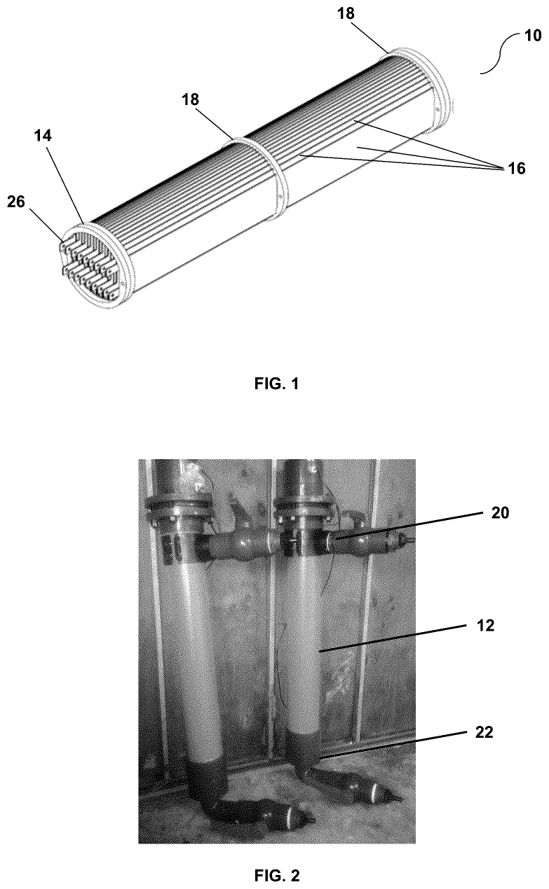

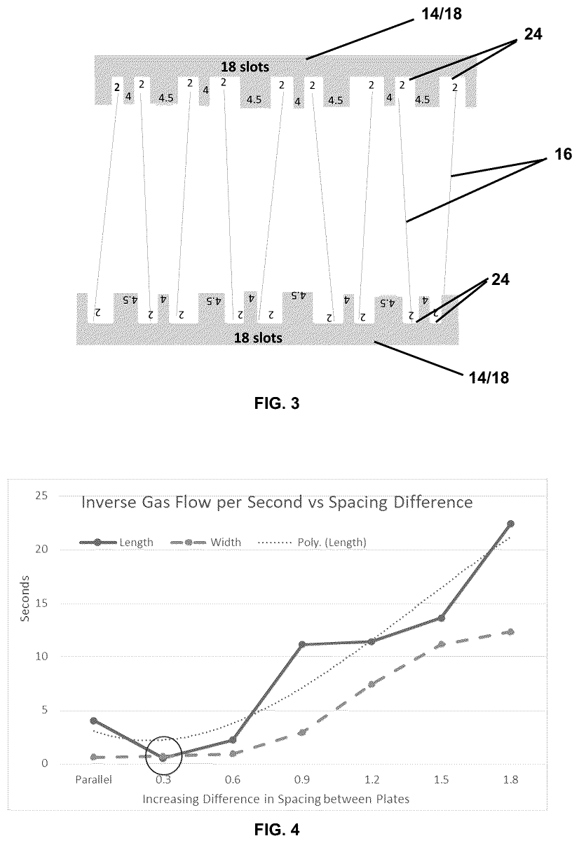

With reference to FIGS. 1 to 3 of the drawings, an electrokinetic disruption generation system 10 is provided for treating a fluid, including but not limited to fluid from treatment plant effluent, industrial effluent, agricultural waters, marine water, and reused or recycled water.

The electrokinetic disruption generation system 10 includes a housing 12, a mount ring 14, a plurality of electrode plates 16 an optional electrode plate guide ring 18, a power supply circuit (not shown) connected or connectable to the electrode plates to form an electrode circuit, and a zinc electron sink (not shown) connected or connectable to the electrode circuit.

The housing 12 is cylindrical and is intended to be located within a pipeline that conveys fluid to be treated. The housing 12 defines a fluid inlet 20 and a fluid outlet 22 at opposed ends of the housing 12. Although the housing 12 has been described as being cylindrical in shape and the mount 14 and electrode plate guide 18 rings have been described as circular in shape, it will be appreciated that the housing 12, the mount 14 and electrode plate guide 18 rings could form alternative shapes (e.g. cubic and ovoid shapes). Fluid to be treated by the electrokinetic disruption generation system 10 is conveyed through the housing 12, from the housing 12 inlet 20 to the housing 12 outlet 22.

The mount ring 14 is located at a first end of the housing 12, adjacent the housing 12 inlet 20. The mount ring 14 and optional electrode plate guide ring 18 define slots 24 for orientating the electrode plates in a non-parallel (angular) position relative to each other. The mount ring 14 comprises a securing means in the form of a nut with bolt (not shown).

The electrode plates 16 are flat, substantially rectangular plates between 1.0 mm and 2 mm in thickness, depending on pipe size and position of the electrodes. Each electrode plate 16 extends into a terminal tab 26 which defines an aperture for receiving the bolt therethrough to secure the electrode plate 16 to the mount ring 14.

Typically, the electrode plates 16 are made of titanium, in particular coated with one or more platinum group metals or metal oxides.

When in use, the electrode plates 16 are disposed within the housing 12, between the housing 12 inlet 20 and the housing 12 outlet 22, such that fluid to be treated flowing through the housing 12 passes along and between the electrode plates 16.

FIG. 1 shows a series of 18 electrode plates 16 arranged in non-parallel, side-by-side relationship (i.e. with their planar surfaces facing each other). However, it is to be appreciated that the electrokinetic disruption generation system 10 may comprise fewer (e.g. 2, 4, 6, 8, 10, 12, or 14) electrode plates 16 arranged in non-parallel, side-by-side relationship. Alternatively, the kinetic disruption generation system 10 may comprise a greater number of electrode plates 16 arranged in non-parallel, side-by-side relationship, depending on the diameter of the water pipe within which the electrokinetic disruption generation system 10 is to be positioned.

Typically, the adjacent electrode plates 16 spaced not less than 4 mm (or multiples of 4 mm, as the applicant has found that this matches the sonic wavelength at the frequencies where the fluid treatment reaction are optimal) from each other.

Furthermore, the edges of the electrode plates are coated with a composite rubber compound to reduce electrical losses along the electrode plates edges and provide a cushion against which each plate can vibrate, returning each plate to its start position after each pulsed movement.

Importantly, adjacent electrode plates 16 are not parallel, being offset with a 0.5 mm difference in the gap between adjacent electrode plates 16 on their first and second long edges. Movement allowance is maximum 0.2 mm from centre of the slots in the mount ring 14 or the optional electrode plate guide ring 18, so that the electrode plates can never be parallel. In other words, adjacent electrode plates 16 diverge/converge at an angle.

The electrode plates 16 are located at their first end within slots 24 defined by the internal surface of the mount ring 14, and the optional electrode plate guide ring 18, and are connected/secured to the mount ring 14 via the nut and bolt (not shown). Importantly, the slots 24 are oversized relative to the dimensions of the portion of the electrode plates 16 received therein so as to permit a degree of “play” between the electrode plates 16 and the mount ring 14, and the optional electrode plate guide ring 18. Similarly, the aperture defined by the electrode plate 16 tab is somewhat oversized relative to the size of the bolt to permit a degree of “play” between the electrode plates 16 and the bolt. Preferably, said connections permit no more than 0.2 mm of movement between the mount ring 14, and the optional electrode plate guide ring 18 and each electrode plate 16.

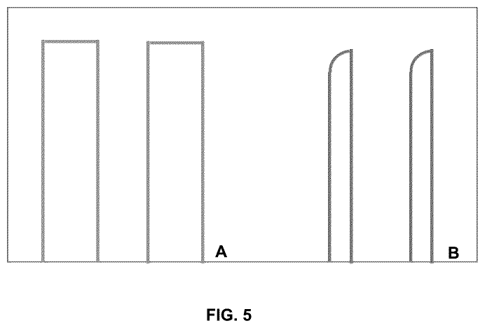

As is evidenced by the results shown in FIG. 4, the angular offset of the electrode plates 16 causes enhanced electrophoresis that is instrumental in increasing the reaction rate within the electrokinetic disruption generation system 10 and which will also increase microorganism destruction due to increased mobility in the oxidising environment and exposure to the sonic pulses.

The controller (not shown), in use, provides alternating first and second pulsed power feeds at first and second voltages, respectively, to the electrode plates 16, such that for an adjacent pair of electrode plates 16, a first electrode plate 16 is fed one of the pulsed power feed and a second electrode 16 is fed the other of the pulsed power feed, thereby causing the electrode plates 16 to move relative to each other and to the mount 14, under the influence of electromotive force. Preferably, the controller varies the voltage amplitude and the frequency of the power pulses and a variable inductance (not shown) associated with the controller varies the wave front form of the power pulses. The preferred wave front form of the power pulses provided by the controller is a square wave with a frequency of between 1 kHertz and 200 kHertz, and a voltage amplitude of between 12.5 V/cm and 150 V\cm.

In one embodiment of the invention, the wave front form of the power pulses is a square wave front form but, as illustrated in FIG. 5 by using duty cycle within the square peak, the peak power period can be shortened to control current flow, and then by adding inductance, the shape of the front of each peak can be controlled so that the duty cycle can be shortened at the point where the capacitance of the electrodes becomes fully charged.

In use, movement of the electrode plates 16 relative to the mount ring 14, when the electrode plates 16 are subjected to power pulses emitted by the controller, generates shock waves within the fluid to be treated contained by the housing 12, which shock waves function (i) to clear the boundary layer on the electrode plate 16 surfaces, (ii) to enhance the chemical reaction rate by creating cavitation as in with the use of ultrasound, (iii) to enhance electroporation and disruption of the external mucous layer of microorganisms, and (iv) to enhance the disruptive forces created by the pulsed electromagnetic field on particulate materials and organic molecules.

Improved sonic pulse radiation into the area surrounding the electrode plates 16, between the edge of the electrode plates 16 and the wall of the water pipe, and induced lateral movement of charged species between the electrode plates 16 also enhances boundary layer renewal between pulses, chemical reactions, disruption of the structure of microorganisms and protective mucous coatings on microorganisms, and disruption of the structure of organic molecules and particulate materials.

The current invention further relates to a method for treating a fluid including by killing and/or removal of microorganisms, disruption of materials such as suspended solids and macromolecules, and aggregation of colloids for further separation from the treated fluid by solid/liquid separation, the method comprising generation of a pulsed electric field (PEF) within the fluid with the use of the electrokinetic disruption generation system of the invention.

In the method of treating a fluid, the electrokinetic disruption generation system may be used together with one or more additional treatment or purification systems either before and/or after the electrokinetic disruption treatment of the fluid, including solid/liquid separation such as by filtration or sedimentation.

1. An electrokinetic disruption generation system for generation of a pulsed electric field (PEF) in a fluid to be treated comprising:
a housing defining a fluid inlet and outlet that in use facilities a flow of the fluid to be treated through the housing;
within the housing, two or more flat, substantially rectangular, electrode plates having a first short end and a second short end and a first long edge and a second long edge, disposed side-by-side in a non-parallel orientation relative to each other, with the planar surface of each electrode plate being angularly spaced relative to the planar surface of an adjacent electrode plate and wherein the edges of each electrode plate are coated with a composite rubber compound;
a mount ring connected or connectable to the housing, having an inner surface comprising a plurality of slots opposed, but offset relative to each other by 0.5 mm, and through which the first short end of the two or more elongate electrode plates passes, such that the slots guide the first short end of the elongate electrode plates such that the planar surface of each electrode plate is angularly spaced relative to the planar surface of an adjacent electrode plate;
optionally at least one electrode plate guide ring disposed within the housing, having an inner surface comprising a plurality of slots opposed, but offset relative to each other by 0.5 mm, and through which the two or more elongate electrode plates pass such that the slots guide the first and second long edges of the elongate electrode plates such that the planar surface of each electrode plate is angularly spaced relative to the planar surface of an adjacent electrode plate;
a power supply connected or connectable to the first end of each elongate electrode plate to form an electrode circuit; and
a zinc electron sink connected or connectable to the electrode circuit,
wherein the spacing between the mount ring slots and the electrode plates and between the optional electrode plate guide ring slots and the electrode plates permits a maximum of 0.2 mm relative movement between the mount ring slots and each electrode plate and between the optional plate guide ring slots and the electrode plates, and
wherein the planar surfaces of the non-parallel electrode plates are spaced not less than 4 mm, or multiples of 4 mm, from each other.

2. The electrokinetic disruption generation system according to claim 1, wherein the composite rubber compound comprises a rubber matrix and a reinforcing material providing a high strength to flexibility ratio including a styrene-butadiene rubber composite, a silica rubber composite, a zinc oxide rubber composite, or a nano-filler or nano-structured filler including graphene, nano-graphite, silica, or carbon nanotubules.

3. The electrokinetic disruption generation system according to either claim 1, wherein the non-parallel, angular spacing of one electrode plate relative to an adjacent plate results in the two adjacent plates being angled relative to each other such that the distance between the adjacent two electrode plates is 0.5 mm greater between a first long edge of the two electrode plates compared to the distance between a second, opposed long edge of the two electrode plates.

4. The electrokinetic disruption generation system according to claim 1, wherein the electrode plates are comprised of titanium or are coated with one or more platinum group metals or metal oxides.

5. The electrokinetic disruption generation system according to claim 1, wherein the fluid treatment system further includes a controller for operably providing alternating first and second pulsed power feeds from a power supply circuit, at first and second voltages respectively, to the electrode plates, such that for an adjacent pair of electrode plates, a first electrode plate is fed one of the pulsed power feed and a second electrode is fed the other of the pulsed power feed, thereby causing the electrode plates to move relative to each other and to the mount ring and optional plate guide ring slots, under the influence of the pulsed power feed-generated electromotive force.

6. The electrokinetic disruption generation system according to claim 5, wherein the controller is adapted to vary the voltage amplitude and the frequency of the power pulses.

7. The electrokinetic disruption generation system according to of claim 5, wherein the fluid treatment system further includes a variable inductance associated with the controller to vary the wave front form of the power pulses.

8. The electrokinetic disruption generation system according to claim 7, wherein the wave front form of the power pulses is a square wave front form adaptable by using duty cycle within the square peak such that the peak power period can be shortened to control current flow, and that by adding inductance, the shape of the front of each peak can be controlled such that the duty cycle can be shortened at the point where the capacitance of the electrodes becomes fully charged.

9. The electrokinetic disruption generation system according to claim 5, wherein the frequency of the power pulses is between 1 kHertz and 200 kHertz; and the voltage amplitude is between 12.5 V/cm and 150 V\cm.

10. A method of treating a fluid, including fluid from treatment plant effluent, industrial effluent, agricultural waters, marine water, or reused or recycled water with the electrokinetic disruption generation system according to claim 1.

11. The method according to claim 10 wherein the method comprises a step of enhancing an advanced oxidation process (AOP) that occurs in the system when water molecules in the fluid being treated are broken down to obtain active oxygen that then forms ozone (O₃), peroxide (H₂O₂) and hydroxyl (OH) radicals.

12. The method according to claim 10 wherein the electrokinetic disruption generation system is used together with one or more additional treatment or purification systems either before and/or after the electrokinetic disruption treatment of the fluid, including solid/liquid separation further including by filtration or sedimentation.

13. (canceled)

14. (canceled)
